(19) United States
(12) Patent Application Publication
(10) Pub. No.: US 2015/0058462 A1
(43) Pub. Date: Feb. 26, 2015

(54) CONTENT DELIVERY SYSTEM WITH CONTENT NAVIGATION MECHANISM AND METHOD OF OPERATION THEREOF

(71) Applicant: Samsung Electronics Co., Ltd., Gyeonggi-Do (KR)

(72) Inventor: Robin M. Tafel, Sunnyvale, CA (US)

(21) Appl. No.: 13/974,727

(22) Filed: Aug. 23, 2013

(51) Int. Cl. H04L 12/24

(52) U.S. Cl. CPC H04L 41/18
USPC 709/223

(57) ABSTRACT

A content delivery system includes: a content article module for providing a content article having content elements; a navigation template module, coupled to the content article module, for generating a navigation template with a source template region and a target template region, the source template region having a navigation destination linking to the target template region and the target template region having a formatting command; a content path module, coupled to the navigation template module, for generating a content path having content nodes by combining the target template region of the navigation template with one of the content elements and formatting one of the content elements with the formatting command; and a content navigation module, coupled to the content path module, for receiving a navigation command for navigating to the navigation destination of the target template region of one of the content nodes for displaying the content article on a device.

### TECHNICAL FIELD

An embodiment of the present invention relates generally to a content delivery system, and more particularly to a system for content navigation.

### BACKGROUND

Modern portable consumer and industrial electronics, especially client devices such as navigation systems, cellular phones, portable digital assistants, and combination devices, are providing increasing levels of functionality to support modern life including personalized content services. Research and development in the existing technologies can take a myriad of different directions.

As users become more empowered with the growth of personalized content service devices, new and old paradigms begin to take advantage of this new device space. There are many technological solutions to take advantage of this new device location opportunity. One existing approach is to evaluate user profile and location information to provide personalized content through a mobile device such as a cell phone, a smart phone, or a personal digital assistant.

Personalized content services allow users to create, transfer, store, and/or consume information in order for users to create, transfer, store, and consume in the “real world.” One such use of personalized content services is to efficiently guide users to the desired product or service.

Content delivery system and personalized content services enabled systems have been incorporated in tablet computers, smart phones, handheld devices, automobiles, and other portable products. Today, these systems aid users by incorporating available, real-time relevant information, such as entertainment, news, advertisements, local businesses, or other points of interest (POI).

However, a content delivery system with a content navigation mechanism has become a paramount concern for the consumer. The inability of existing content delivery system to provide a content navigation mechanism decreases the benefit of using the system due to poor user experience.

Thus, a need still remains for a content delivery system with a content navigation mechanism with a more effective, useable and engaging content navigation mechanism. In view of the ever-increasing commercial competitive pressures, along with growing consumer expectations and the diminishing opportunities for meaningful product differentiation in the marketplace, it is critical that answers be found for these problems. Additionally, the need to reduce costs, improve efficiencies and performance, and meet competitive pressures adds an even greater urgency to the critical necessity for finding answers to these problems.

Solutions to these problems have been long sought but prior developments have not taught or suggested any solutions and, thus, solutions to these problems have long eluded those skilled in the art.

### SUMMARY

An embodiment of the present invention provides a content delivery system, including: a content article module for providing a content article having content elements; a navigation template module, coupled to the content article module, for generating a navigation template with a source template region and a target template region, the source template region having a navigation destination linking to the target template region and the target template region having a formatting command; a content path module, coupled to the navigation template module, for generating a content path having content nodes by combining the target template region of the navigation template with one of the content elements and formatting one of the content elements with the formatting command; and a content navigation module, coupled to the content path module, for receiving a navigation command for navigating to the navigation destination of the target template region of one of the content nodes for displaying the content article on a device.

An embodiment of the present invention provides a method of operation of a content delivery system including: providing a content article having content elements; generating a navigation template with a source template region and a target template region, the source template region having a navigation destination linking to the target template region and the target template region having a formatting command; generating a content path having content nodes by combining the target template region of the navigation template with one of the content elements and formatting one of the content elements with the formatting command; and receiving a navigation command for navigating to the navigation destination of the target template region of one of the content nodes for displaying the content article on a device.

Certain embodiments of the invention have other steps or elements in addition to or in place of those mentioned above. The steps or elements will become apparent to those skilled in the art from a reading of the following detailed description when taken with reference to the accompanying drawings.

### BRIEF DESCRIPTION OF THE DRAWINGS

FIG. 1 is a content delivery system with content navigation mechanism in an embodiment of the present invention.

FIG. 2 is an example of a display of the content delivery system.

FIG. 3 is an exemplary architectural diagram of providing the content article from an aggregation of content sources.

FIG. 4 is an example of a display of a navigation template of the content delivery system.

FIG. 5 is an example of a content path for the display of the content delivery system.

FIG. 6 is an example of a display of the target content element of the content delivery system.

FIG. 7 is an example of navigating the content path of the display of the content delivery system.

FIG. 8 is a functional block diagram of the content delivery system.

FIG. 9 is a control flow of the content delivery system.

FIG. 10 is a flow chart of a method of operation of the content delivery system in a further embodiment of the present invention.

### DETAILED DESCRIPTION

An embodiment of the present invention provides that forming the content nodes using one of the template regions having the navigation destination and the formatting command improves the readability of the content article. By navigating along the content path in a particular order, the effectiveness of presentation of the content article is enhanced over a random or non-specific order by allowing a pre-defined route that presents the content elements in a pre-defined and content-based order.

An embodiment of the present invention provides that formatting one of the content elements by applying the formatting command to one of the content elements increases the readability of the content article by increasing the quality factor of the display content. Applying the formatting command, including the zoom factor, to one of the content elements having the text block increases the size of the text and increases readability.

An embodiment of the present invention provides that configuring the source template region to have multiple instances of the target template region and navigating to different instances of the target template region increases reading performance and flexibility. Multiple destination instances of the target template region for the source template region allows for multiple reading scenarios and providing an improved user experience and enhanced readability.

An embodiment of the present invention provides increased functionality and improved navigation by processing multiple instances of the navigation command to determine multiple instances of the target content node. By providing content-sensitive processing of the navigation command, the content delivery system can improve the magazine reading experience.

The following embodiments are described in sufficient detail to enable those skilled in the art to make and use the invention. It is to be understood that other embodiments would be evident based on the present disclosure, and that system, process, or mechanical changes may be made without departing from the scope of an embodiment of the present invention.

In the following description, numerous specific details are given to provide a thorough understanding of the invention. However, it will be apparent that the invention may be practiced without these specific details. In order to avoid obscuring an embodiment of the present invention, some well-known circuits, system configurations, and process steps are not disclosed in detail.

The drawings showing embodiments of the system are semi-diagrammatic, and not to scale and, particularly, some of the dimensions are for the clarity of presentation and are shown exaggerated in the drawing figures. Similarly, although the views in the drawings for ease of description generally show similar orientations, this depiction in the figures is arbitrary for the most part. Generally, the invention can be operated in any orientation. The embodiments have been numbered first embodiment, second embodiment, etc. as a matter of descriptive convenience and are not intended to have any other significance or provide limitations for an embodiment of the present invention.

The term “module” referred to herein can include software, hardware, or a combination thereof in an embodiment of the present invention in accordance with the context in which the term is used. For example, the software can be machine code, firmware, embedded code, and application software. Also for example, the hardware can be circuitry, processor, computer, integrated circuit, integrated circuit cores, a pressure sensor, an inertial sensor, a microelectromechanical system (MEMS), passive devices, or a combination thereof.

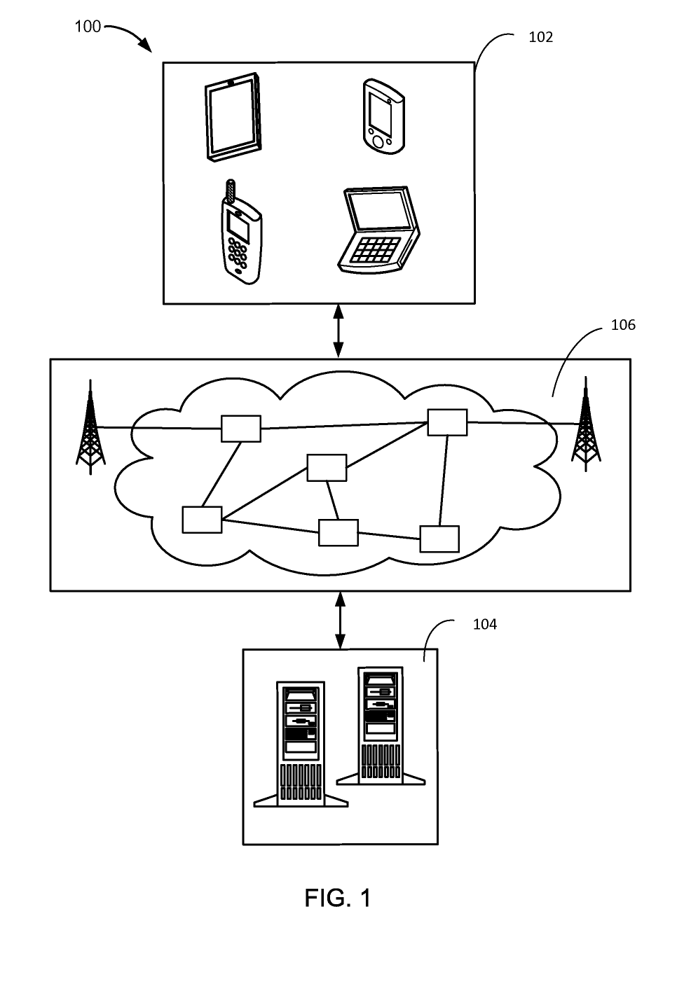

Referring now to FIG. 1, therein is shown a content delivery system 100 with content navigation mechanism in an embodiment of the present invention. The content delivery system 100 includes a first device 102, such as a client or a server, connected to a second device 104, such as a client or server, with a communication path 106, such as a wireless or wired network.

For example, the first device 102 can be of any of a variety of mobile devices, such as a tablet computer, smart phone, personal digital assistant, a notebook computer, automotive telematics content delivery system, or other multi-functional mobile communication or entertainment device. The first device 102 can be a standalone device, or can be incorporated with a vehicle, for example a car, truck, bus, or train. The first device 102 can couple to the communication path 106 to communicate with the second device 104.

For illustrative purposes, the content delivery system 100 is described with the first device 102 as a mobile computing device, although it is understood that the first device 102 can be different types of computing devices. For example, the first device 102 can also be a non-mobile computing device, such as a server, a server farm, or a desktop computer. In another example, the first device 102 can be a non-mobile computing device, such as a desktop computer, a large format display (LFD), a television (TV), kiosk, or a computer terminal.

The second device 104 can be any of a variety of centralized or decentralized computing devices. For example, the second device 104 can be a computer, grid computing resources, a virtualized computer resource, cloud computing resource, routers, switches, peer-to-peer distributed computing devices, or a combination thereof.

The second device 104 can be centralized in a single computer room, distributed across different rooms, distributed across different geographical locations, embedded within a telecommunications network. The second device 104 can have a means for coupling with the communication path 106 to communicate with the first device 102. The second device 104 can also be a client type device as described for the first device 102.

In another example, the first device 102 can be a particularized machine, such as a mainframe, a server, a cluster server, rack mounted server, or a blade server, or as more specific examples, an IBM System z10™ Business Class mainframe or a HP ProLiant ML™ server. Yet another example, the second device 104 can be a particularized machine, such as a portable computing device, a thin client, a notebook, a netbook, a smartphone, personal digital assistant, or a cellular phone, and as specific examples, an Apple iPhone™, Apple iPad™, Samsung Galaxy™, or Moto Q Global™.

For illustrative purposes, the content delivery system 100 is described with the second device 104 as a non-mobile computing device, although it is understood that the second device 104 can be different types of computing devices. For example, the second device 104 can also be a mobile computing device, such as notebook computer, another client device, or a different type of client device. The second device 104 can be a standalone device, or can be incorporated with a vehicle, for example a car, truck, bus, or train.

Also for illustrative purposes, the content delivery system 100 is shown with the second device 104 and the first device 102 as end points of the communication path 106, although it is understood that the content delivery system 100 can have a different partition between the first device 102, the second device 104, and the communication path 106. For example, the first device 102, the second device 104, or a combination thereof can also function as part of the communication path 106.

The communication path 106 can be a variety of networks. For example, the communication path 106 can include wireless communication, wired communication, optical, ultrasonic, or the combination thereof. Satellite communication, cellular communication, Bluetooth, Infrared Data Association standard (IrDA), near field communication (NFC), wireless fidelity (WiFi), and worldwide interoperability for microwave access (WiMAX) are examples of wireless communication that can be included in the communication path 106. Ethernet, digital subscriber line (DSL), fiber to the home (FTTH), and plain old telephone service (POTS) are examples of wired communication that can be included in the communication path 106.

Further, the communication path 106 can traverse a number of network topologies and distances. For example, the communication path 106 can include direct connection, personal area network (PAN), local area network (LAN), metropolitan area network (MAN), wide area network (WAN) or any combination thereof.

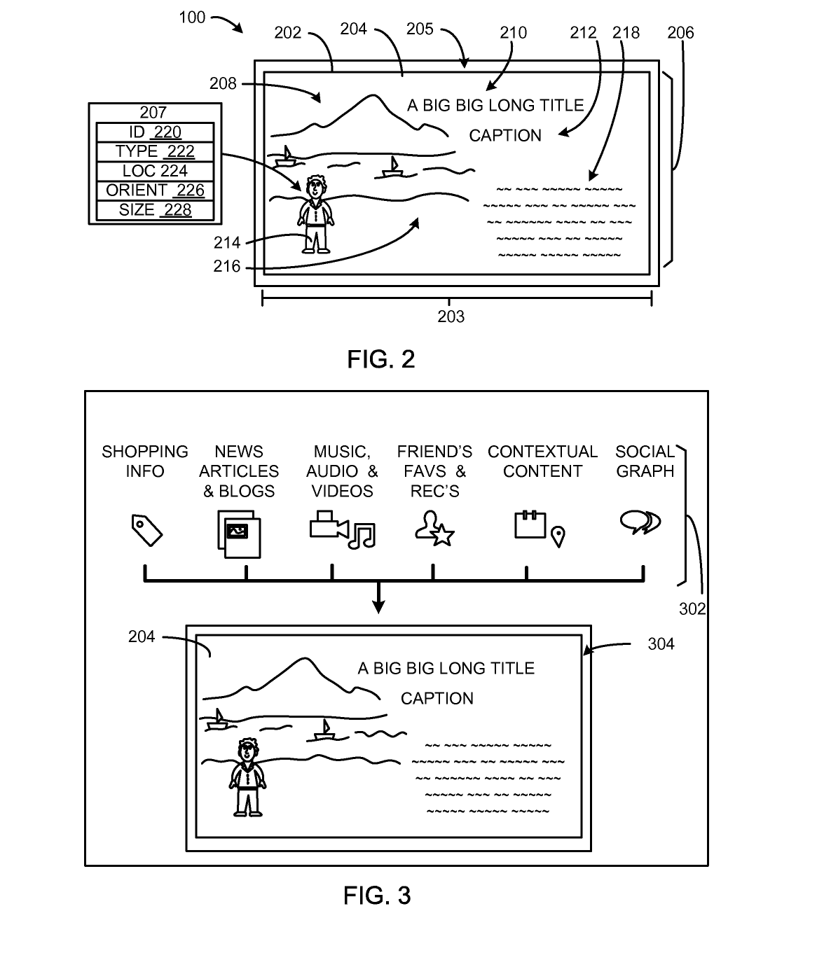

Referring now to FIG. 2, therein is shown an example of a display content 205 of the content delivery system 100. The content delivery system 100 can determine the display content 205 for displaying a content article 204 on a display interface 202.

The content article 204 is a unit of information for viewing together as a single entity. For example, the content article 204 can include a digital magazine story, digital newspaper story, a news feed story, web content, or a combination thereof. Viewing can include reading text, watching a video presentation, listening to an audio element, or a combination thereof. The content article 204 can include a social layer for both a method of sharing the content as well as displaying information/comments/recommendations from your social graph that is relevant to the content you are currently consuming.

The display content 205 is a portion of the content information of the content article 204 displayed on the display interface 202. The display content 205 can be presented to provide a “magazine experience” when viewing the content article 204. The “magazine experience” is viewing the content in a manner similar to reading a physical magazine including directing the attention of the reader, providing high quality images for viewing, combining text and image, or a combination thereof.

The display interface 202 can have a display size 203, which can determine the readability of the display content 205 displayed on the display interface 202. The display size 203 can include a pixel dimension, a physical length and width, or a combination thereof. Readability is the level of ease at which content can be viewed on the display interface 202. For example, if the display content 205 uses a four point font with no zoom factor to display text on the display interface 202, then the readability will be low.

The content article 204 can include content elements 206. The content elements 206 are units of information that are combined to convey the message of the content article 204. For example, the content elements 206 can include a title 210, a caption 212, a main image 208, a graphic 214, a subimage 216, a text block 218, an audio, a video, or a combination thereof.

The content elements 206 can include a content tag 207. The content tag 207 is an identifier that describes the type of content in one of the content elements 206. For example, the graphic 214 can include the content tag 207 for a “graphic” element.

The content tag 207 can include a text field, a binary identifier, or a combination thereof. For example, the content tag 207 can include a content element identifier 220, a content element type 222, a content element location 224, a content element orientation 226, a content element size 228, or a combination thereof.

The content element identifier 220 is a text or binary value to identify or label one of the content elements 206. The content element type 222 is a description of the type of one of the content elements 206. The content element orientation 226 is a description of the orientation of one of the content elements 206. The content element size 228 is a value indicating the size of one of the content elements 206.

The amount of information in the content article 204 can be more than can be presented at one time on the display interface 202. The content delivery system 100 allows a reader to navigate through the content elements 206 by displaying different subsets of the content elements 206 in the display content 205 at different times.

The display content 205 can be updated during the navigation of the content article 204 to display the content elements 206 in a formatted manner. The content delivery system 100 can provide a specific path through the content article 204 to enhance the viewing experience.

In further example, during the navigation through the content article 204, the display content 205 can display a series of the content elements 206 each formatted for the size of the display interface 202. The display content 205 can first display the title 210, then the caption 212, then the graphic 214, then the subimage 216, and then the text block 218. In yet further example, the display content 205 can display the text block 218 formatted and zoomed in to insure the text can be read on the display interface 202.

The display interface 202 is shown displaying the display content 205 in a landscape orientation. However, it is understood that the display content 205 can be displayed in either landscape or portrait orientation depending on the orientation of the display interface 202 of the first device 102 of FIG. 1. It is also understood that the orientation of the display content 205 can change dynamically as the orientation of the display interface 202 changes from portrait to landscape or vice versa.

Referring now to FIG. 3, therein is shown an exemplary architectural diagram of providing the content article 204 from an aggregation of content sources 302. For example, the content delivery system 100 of FIG. 1 can provide the content article 204 by retrieving information from a set of the content sources 302.

The content sources 302 are information suppliers selected to accommodate the user needs and preferences. For example, the content sources 302 can include information such as shopping information, news articles, blogs, audio, video, or a combination thereof.

The selection of the content sources 302 can be customized using the user's social graph, friend recommendations, preferences, expert recommendations, public information, or a combination thereof. The selection of the content sources 302 can be performed using contextual information about the user including current location, time, date, destination, social context, current activity, or a combination thereof.

For example, the content delivery system 100 can receive an electronic message containing a description that several of the user's Facebook™ contacts read Wired™ magazine. The content delivery system 100 can select Wired™ as one of the content sources 302 and retrieve the content article 204 from the Wired™ website.

In another example, the content delivery system 100 can receive an electronic message indicating a location, such as New York. The content delivery system 100 can select the website of the New York City Tourist Bureau as one of the content sources 302 by matching the name of the location to a list of known content sources on the web and then retrieve the content article from the New York Tourist Bureau website.

In another example, the content article 204 can include product information can be generated from prior shopping information of the user. The content delivery system 100 can receive a file containing the user's shopping history and create the content article 204 as a virtual catalog of household appliances from Macy's™ website having the same brand as a recent user purchase of a microwave oven.

In a further example, the source of the content article 204 can be a set of Facebook™ images retrieved from the account of a Facebook™ friend. The content delivery system 100 can select the Facebook™ images that have a status of “like” and a geographical location near the current location of the user.

The content article 204 can be provided in a variety of other ways. Although the content article 204 can be generated from an aggregation of the content sources 302, it is understood that the content article 204 be generated from a single content source, retrieved as a file from a data storage unit, received as a network transmission, or a combination thereof.

In an illustrative example, the display content 205 of FIG. 2 can depict an initial view 304. The initial view 304 is the depiction of the display content 205 that is displayed the first time the content article 204 is viewed. The initial view 304 can provide an overview of the content article 204 and indicate the navigation options available in the content article 204.

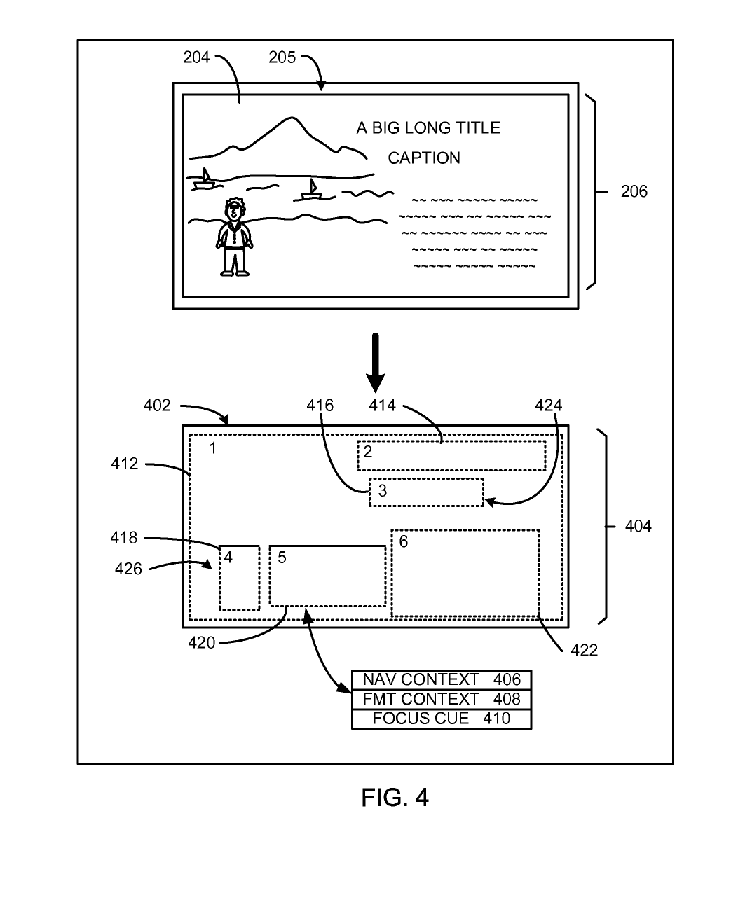

Referring now to FIG. 4, therein is shown an example of a display of a navigation template 402 of the content delivery system 100 of FIG. 1. The content delivery system 100 can navigate through the content elements 206 of the content article 204 using the navigation template 402.

The navigation template 402 is a control element for regulating the content navigation between the content elements 206. Content navigation is the pattern of information displayed in the display content 205 during the traversal from one of the content elements 206 to another of the content elements 206. For example, content navigation can allow reading the content article 204 by moving from the title 210 of FIG. 2 to the graphic 214 of FIG. 2, and then to the text block 218 of FIG. 2.

The navigation template 402 can include template regions 404. The template regions 404 are navigation and formatting elements associated with the content elements 206 of the content article 204. The template regions 404 are linked to locations in the content article 204 that correspond to the content elements 206.

The template regions 404 can include a navigation destination 406. The navigation destination 406 is information for one of the template regions 404 that describes another of the template regions 404 as a destination during content navigation. The navigation destination 406 can indicate a destination from one of the template regions 404.

The template regions 404 can include a formatting command 408. The formatting command 408 is information used to format one of the template regions 404 for the display content 205. For example, the formatting command 408 can include a zoom factor, a pan rate, a path for panning the display, a color palette, a contract value, a transition rate, or a combination thereof.

The template regions 404 can include a focus cue 410. The focus cue 410 is a visual element or effect to draw attention to one of the template regions 404. The focus cue 410 can include effects such as enhanced contrast, alternate color palette, video effects, alternating images, altered text, outlining, flashing, pixel enhancement, or a combination thereof.

For example, the focus cue 410 can include changing the color palette of one of the content elements 206 associated with one of the template regions 404 to only include black and white colors. The difference in color can make one of the content elements 206 stand out from the other instances of the content elements 206. The focus cue 410 can be applied to one of the template regions 404 to draw attention to the region to enhance the likelihood of navigation and increase the overall “magazine experience” by providing visual cues to help guide the content navigation through the content article 204.

The navigation template 402 can include the navigation regions 404 that are linked to the content elements 206. Linked is having an information indicating an association between one of the template regions 404 and one of the content elements 206. One of the navigation regions 404 is linked to one of the content elements 206 by having a pointer or other information identifying the associated instance of one of the content elements 206.

In an illustrative example, the set of the template regions 404 can include a first template region 412, a second template region 414, and a third template region 416. The template regions 404 can include a fourth template region 418, a fifth template region 420, and a sixth template region 422.

The first template region 412 can be linked to the main image 208 of FIG. 2. The second template region 414 can be linked to the title 210. The third template region 416 can be linked to the caption 212 of FIG. 2. The fourth template region 418 can be linked to the graphic 214. The fifth template region 420 can be linked to the subimage 216 of FIG. 2. The sixth template region 422 can be linked to the text block 218.

Although a fixed number of the template regions 404 are used in this illustrative example, it is understood that there can be any number of the template regions 404 in the navigation template 402. For example, the navigation template 402 can have ten of the template regions 404, each corresponding to the content elements 206 of the content article 204.

The template regions 404 can include a source template region 424 and a target template region 426. The source template region 424 is one of the template regions 404 that acts as a starting point for navigation. The target template region 426 is one of the template regions 404 that is a navigation destination. For example, the content delivery system 100 can perform content navigation from the source template region 424 to the target template region 426. The target template region 426 can be designated to be formatted using the formatting command 408 of the target template region 426.

The navigation template 402 can be formed in a variety of ways. The navigation template 402 can be generated using the content elements 206 of the content article 204, manually generated, or a combination thereof.

For example, the navigation template 402 can automatically create one of the template regions 404 for each of the content elements 206 in the content article 204. Each of the template regions 404 can be linked with an identifier indicating the associated instance of the content elements 206.

The navigation destination 406 of each of the template regions 404 can be assigned to instance of the template regions 404 associated with the next sequential instance of the content elements 206. The formatting command 408 of each of the template regions 404 can be assigned using a pre-defined list giving the formatting command 408 for each type of the content elements 206.

In another example, the navigation template 402 can be created manually. A user interface can be used to create an instance of the template regions 404 and link it to one of the content elements 206 to provide the navigation destination 406. The formatting command 408 for each of the template regions 404 can be assigned manually.

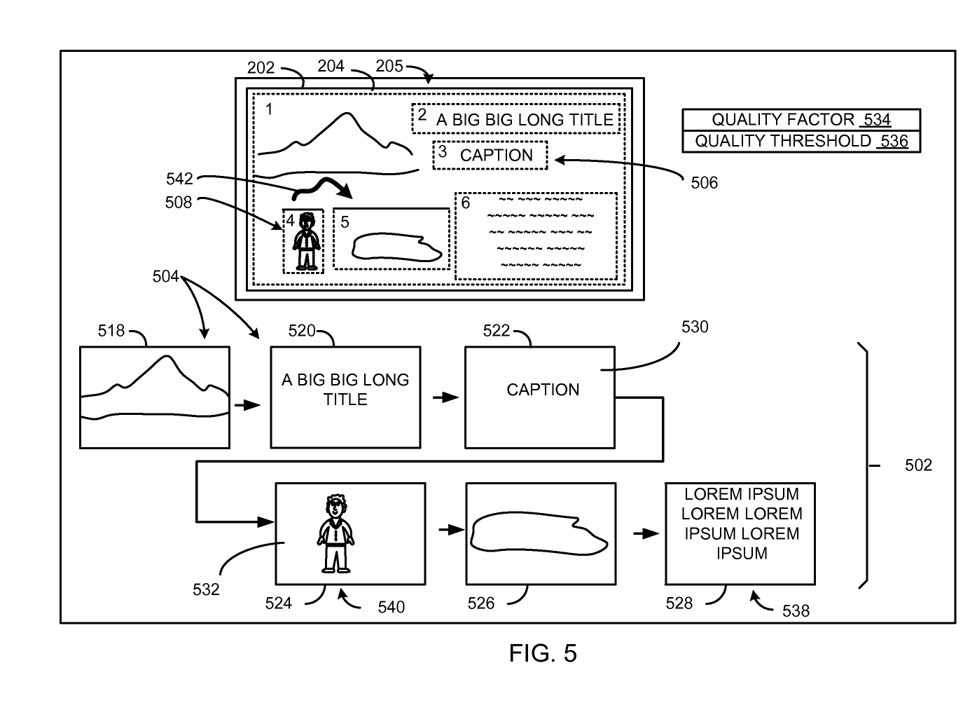

Referring now to FIG. 5, therein is shown an example of a content path 502 for the display of the content delivery system 100 of FIG. 1. The content delivery system 100 can navigate the content article 204 by displaying the display content 205 along the content path 502.

The content path 502 is a navigational route through the content elements 206 of FIG. 2 of the content article 204 following the navigation destination 406 of FIG. 4 of each of the template regions 404 of FIG. 4. The content path 502 includes content nodes 504. The content nodes 504 are entries along the content path 502 representing the content elements 206 formatted with the formatting command 408 of FIG. 4 of the template regions 404.

The content path 502 includes the instances of the display content 205 of the content nodes 504 displayed as the content article 204 is traversed along the instances of the navigation destination 406 for the navigation template 402 of FIG. 4. The content nodes 504 can represent each of the content elements 206 formatted using the formatting command 408 of each of the associated instances of the template regions 404.

The content nodes 504 can include a source content node 530, which is one of the content nodes 504 formed by combining the source template region 424 of FIG. 4 with a source content element 506. The source content element 506 is one of the content elements 206 associated with the source template region 424.

The content nodes 504 can include a target content node 532, which is one of the content nodes 504 formed by combining the target template region 426 of FIG. 4 with a target content element 508. The target content element 508 is one of the content elements 206 associated with the target template region 426. For example, the user can navigate from the source content node 530 to the target content node 532 along the content path 502.

The source content element 506 is one of the content elements 206 of FIG. 2 associated with one of the source template region 424. The target content element 508 is another of the content elements 206 associated with the target template region 426.

The content path 502 includes the combination of the navigation and formatting of the content elements 206 in the navigation template 402. The content path 502 can generate the display content 205 for each the template regions 404 in the navigation template 402.

For example, the content path 502 routes across the content elements 206 including the main image 208 of FIG. 2, the title 210 of FIG. 2, the caption 212 of FIG. 2, the graphic 214 of FIG. 2, the subimage 216 of FIG. 2, and the text block 218 of FIG. 2. Displaying the content path 502 includes formatting the display content 205 for each of the content elements 206 by applying the formatting command 408 of the template regions 404 to the instance of the content elements 206.

The order of navigation of the content path 502 is determined by the navigation destination 406 of each of the template regions 404 of the navigation template 402. The formatting command 408 can include the final format of the content elements 206 as well as transition effects such as panning, zooming, fades, wipes, or a combination thereof.

The content nodes 504 include the display content 205 of one of the content elements 206 combined with the navigation destination 406, the formatting command 408, and the focus cue 410 of FIG. 4 of one of the template regions 404. The content nodes 504 are displayed as the display content 205 on the display interface 202.

In an illustrative example, the content path 502 can include a first content node 518 displaying the main image 208 of the first template region 412 of FIG. 4. The content path 502 can include a second content node 520 displaying the title 210 of the second template region 414 of FIG. 4. The content path 502 can include a third content node 522 displaying the caption 212 of the third template region 416 of FIG. 4.

The content path 502 can include a fourth content node 524 displaying the graphic 214 of the fourth template region 418 of FIG. 4. The content path 502 can include a fifth content node 526 displaying the subimage 216 of the fifth template region 420 of FIG. 4. The content path 502 can include a sixth content node 528 displaying the text block 218 of the sixth template region 422 of FIG. 4.

The first content node 518 can represent the display content 205 of the main image 208 formatted with the formatting command 408 of the first template region 412. The formatting command 408 can be applied to format the main image 208 for display on the display interface 202. The navigation destination 406 of the first template region 412 can include a link to the second template region 414.

The second content node 520 represents the display content 205 of the title 210 formatted with the formatting command 408 of the second template region 414. The navigation destination 406 of the second template region 414 can include a link to the third template region 416.

The formatting command 408 is applied to format the title 210 for display on the display interface 202. The formatting command 408 can include a text formatting 538 to set the font size and word wrap characteristics of the title 210 to fit the size of the display interface 202.

The third content node 522 represents the display content 205 of the caption 212 formatted with the formatting command 408 of the third template region 416. The formatting command 408 can be applied to format the caption 212 for display on the display interface 202. The navigation destination 406 of the third template region 416 can include a link to the fourth template region 418.

The fourth content node 524 represents the display content 205 of the graphic 214. The formatting command 408 can be applied to format the graphic 214 for display on the display interface 202. The navigation destination 406 of the fourth template region 418 can include a link to the fifth template region 420.

The formatting command 408 for the fourth template region 418 can include a zoom factor 540, which is a magnification value. The zoom factor 540 can be used to increase the size of the graphic 214 to match the size of the available space on the display interface 202.

The formatting command 408 can also include a panning path 542 to pan from the display content 205 of the third content node 522 to the display content 205 of the fourth content node 524. The panning path 542 is a visual route for traversing from the source content node 530 to the target content node 532. Traversing is changing from the display content 205 the source content node 530 to the display content 205 of the target content node 532.

For example, the panning path 542 can indicate traversing from the source content node 530 associated with the title 210 to the target content node 532 associated with the graphic 214 along a route describing an arc segment of a circle. In another example, the panning path 542 can indicate moving from the source content node 530 associated with the title 210 to the target content node 532 associated with the text block 218 along a straight-line route.

The fifth content node 526 can be the display content 205 of the subimage 216. The formatting command 408 can be used to format the subimage 216 for display on the display interface 202. The navigation destination 406 of the fifth template region 420 can include a link to the sixth template region 422.

The sixth content node 528 can be the display content 205 of the text block 218. The navigation destination 406 of the sixth template region 422 can include a link to another one of the template regions 404, another of the navigation template 402 of another page of the content article 204, another instance of the content article 204, or a combination thereof.

The formatting command 408 can be applied to format the text block 218 for display on the display interface 202. The formatting command 408 can include the zoom factor 540 for formatting the text block 218 to be readable on the display interface 202.

The content delivery system 100 can calculate a quality factor 534 for each of the content nodes 504. The quality factor 534 is a measure the viewing experience of the display content 205 displayed on the display interface 202. The quality factor 534 can measure a variety of factors including readability, legibility, quantization of information, anti-aliasing, resolution differences, or a combination thereof.

The quality factor 534 can be calculated in a variety of ways. For example, the quality factor 534 for the text block 218 can be calculated by determining the size of the characters displayed in the text block 218 on the display interface 202 having the display size 203 of FIG. 2. If the size of the characters is below the equivalent of a ten point font, then the quality factor 534 can be set to 75%.

In another example, the quality factor 534 of the subimage 216 can be calculated by determining the pixel dimensions of the subimage 216 and comparing to the display size 203. If the pixel dimensions of the subimage 216 are larger than the pixel dimensions of the display size 203, then the subimage 216 cannot fit on the display without zooming, so the quality factor 534 can be set to a value of 80%.

For example, if the main image 208 can be displayed on the display interface 202 at full pixel resolution with no missing elements, then the quality factor 534 of the display content 205 is 100%. If the display content 205 displays the main image 208 at a reduced pixel resolution and digital compression artifacts, then the quality factor 534 can be 60%.

In another example, the quality factor 534 can be a measurement of legibility for the display content 205 of the text block 218. If the text block 218 can be entirely displayed on the display interface 202 at the zoom factor 540 that allows the text block 218 to be read for the display size 203 of the display interface 202, then the quality factor 534 can be 100%. If the text block 218 can only be partially displayed on the display interface 202, then the quality factor 534 can be set to 50%.

The content delivery system 100 can compare the quality factor 534 of one of the content nodes 504 to a quality threshold 536 to determine if the quality factor 534 meets or exceeds the quality threshold 536. The quality threshold 536 is a value indicating the minimum level of quality at which the content can be viewed. For example, the quality threshold 536 for text could indicate that the display content 205 should provide the equivalent of a twelve point font. The quality threshold 536 can be pre-defined or looked up in a lookup table.

If the quality factor 534 of one of the content nodes 504 is below the quality threshold 536, the content delivery system 100 can automatically reformat the display content 205 to meet the quality threshold 536. For example, if the quality factor 534 of the display content 205 of the text block 218 is too low, then the zoom factor can be increased to improve the legibility of the text block 218.

It has been discovered that forming the content nodes 504 using one of the template regions 404 having the navigation destination 406 and the formatting command 408 improves the readability of the content article 204. By navigating along the content path 502 in a particular order, the effectiveness of presentation of the content article 204 is enhanced over a random or non-specific order by allowing a pre-defined route that presents the content elements 206 in a pre-defined and content-based order.

It has been discovered that formatting one of the content elements 206 by applying the formatting command 408 to one of the content elements 206 increases the readability of the content article 204 by increasing the quality factor 534 of the display content 205. Applying the formatting command 408, including the zoom factor 540, to one of the content elements 206 having the text block 218 increases the size of the text and increases readability.

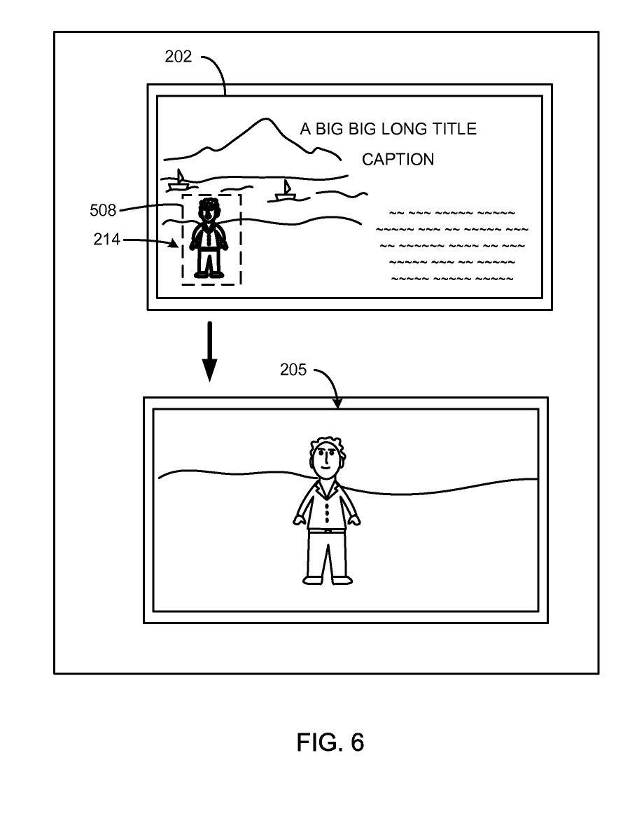

Referring now to FIG. 6, therein is shown an example of a display of the target content element 508 of the content delivery system 100 of FIG. 1. The target content element 508, such as the graphic 214, can be combined with the target template region 426 of FIG. 4 of the navigation template 402 of FIG. 4 to generate the display content 205 for displaying on the display interface 202.

For example, the target template region 426 can include the formatting command 408 of FIG. 4 having the zoom factor 540 of FIG. 5 set to maximize the size on the graphic 214 on the display interface 202. The content delivery system 100 can combine the target template region 426 with the graphic 214 to form the display content 205 for display on the display interface 202.

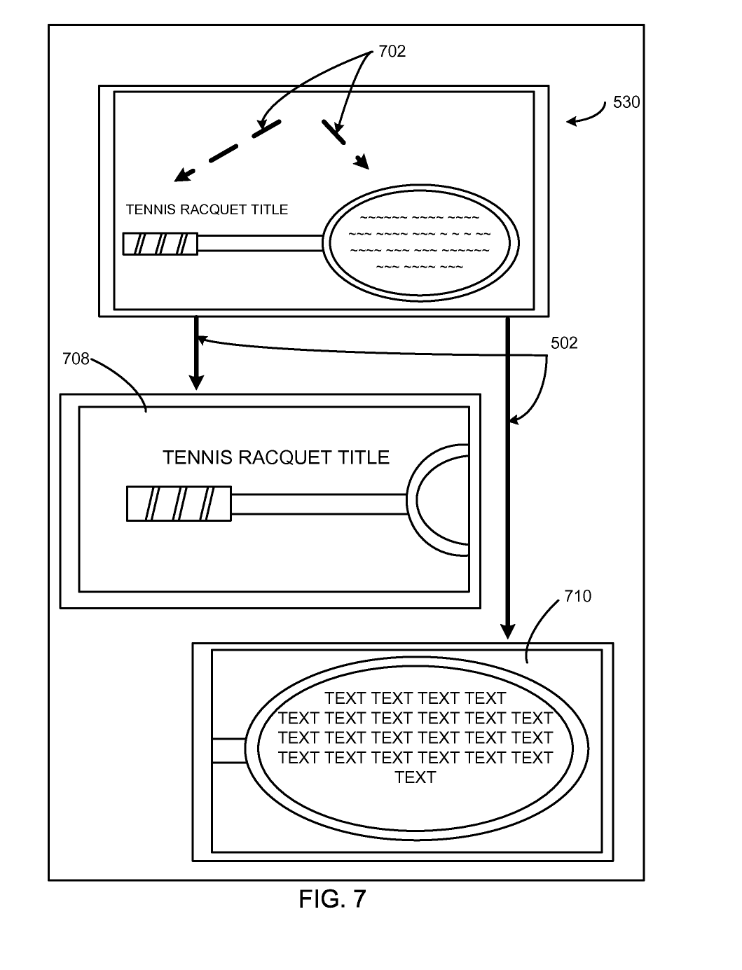

Referring now to FIG. 7, therein is shown an example of navigating the content path 502 of the display of the content delivery system 100 of FIG. 1. The content path 502 can include the source content node 530 associated with one of the template regions 404 of FIG. 4 having a plurality of instances of the target content node 532 of FIG. 5. The content delivery system 100 can select the target content node 532 by receiving a navigation command 702 identifying the target content node 532.

The navigation command 702 is an instruction to perform a navigation operation. For example, the navigation operation can include a default command, a command identifying a target destination, or a combination thereof.

The navigation command 702 can be received as a user input of the content delivery system 100. For example, the navigation command 702 can include a touchscreen gesture, a three-dimensional gesture, a keyboard command, a button click, or a combination thereof.

The navigation destination 406 of FIG. 4 of the source template region 424 of FIG. 4 can include information describing multiple instances of the target template region 426 of FIG. 4 linked to different instances of the navigation command 702. The navigation destination 406 can navigate to a different instance of the target template region 426 by receiving different instances of the navigation command 702 associated with the target template region 426.

For example, the navigation command 702 can be a “default action” which can navigate to the next instance of the content nodes 504 of FIG. 5 in the content path 502. In another example, the navigation command 702 can be a “left swipe” which can navigate to a first content node 708 designated for the “handle caption”. In yet another example, the navigation command 702 can be a “right swipe” which can navigate to a second content nodes 710 designated for the “racquet text block”.

It has been discovered that configuring the source template region 424 to have multiple instances of the target template region 426 and navigating to different instances of the target template region 426 increases reading performance and flexibility. Multiple destination instances of the target template region 426 for the source template region 424 allows for multiple reading scenarios and providing an improved user experience and enhanced readability.

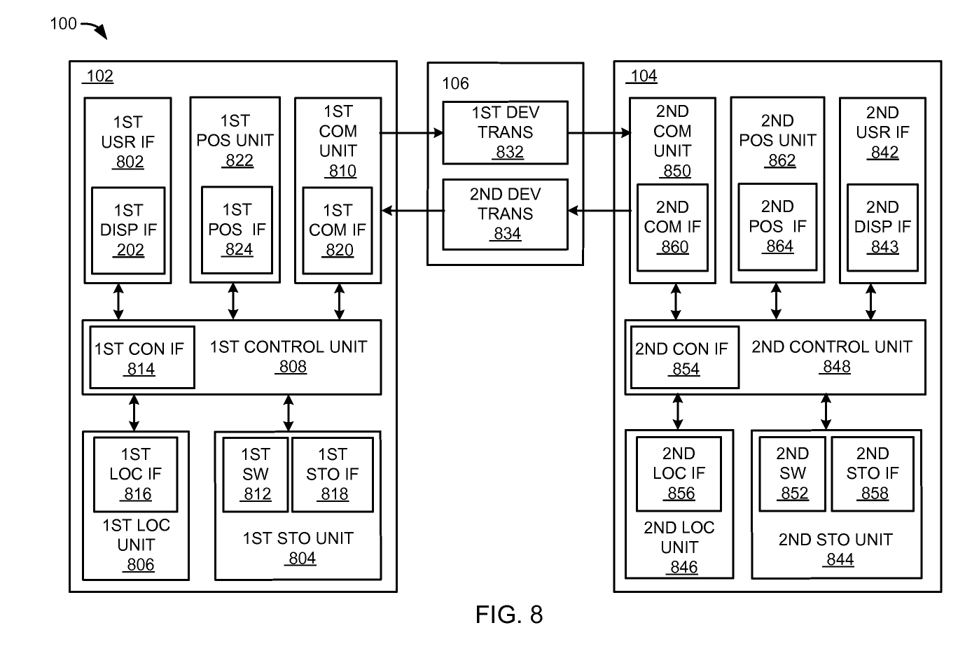

Referring now to FIG. 8, therein is shown a functional block diagram of the content delivery system 100. The content delivery system 100 can include the first device 102, the communication path 106, and the second device 104.

The first device 102 can communicate with the second device 104 over the communication path 106. The first device 102 can send information in a first device transmission 832 over the communication path 106 to the second device 104. The second device 104 can send information in a second device transmission 834 over the communication path 106 to the first device 102.

For illustrative purposes, the content delivery system 100 is shown with the first device 102 as a client device, although it is understood that the content delivery system 100 can have the first device 102 as a different type of device. For example, the first device can be a server.

Also for illustrative purposes, the content delivery system 100 is shown with the second device 104 as a server, although it is understood that the content delivery system 100 can have the second device 104 as a different type of device. For example, the second device 104 can be a client device.

For brevity of description in this embodiment of the present invention, the first device 102 will be described as a client device, such as a smart phone. The embodiment of the present invention is not limited to this selection for the type of devices. The selection is an example of the embodiment of the present invention.

The first device 102 can include a first control unit 808. The first control unit 808 can include a first control interface 814. The first control unit 808 can execute a first software 812 to provide the intelligence of the content delivery system 100.

The first control unit 808 can be implemented in a number of different manners. For example, the first control unit 808 can be a processor, an embedded processor, a microprocessor, a hardware control logic, a hardware finite state machine (FSM), a digital signal processor (DSP), or a combination thereof.

The first control interface 814 can be used for communication between the first control unit 808 and other functional units in the first device 102. The first control interface 814 can also be used for communication that is external to the first device 102.

The first control interface 814 can receive information from the other functional units or from external sources, or can transmit information to the other functional units or to external destinations. The external sources and the external destinations refer to sources and destinations external to the first device 102.

The first control interface 814 can be implemented in different ways and can include different implementations depending on which functional units or external units are being interfaced with the first control interface 814. For example, the first control interface 814 can be implemented with electrical circuitry, microelectromechanical systems (MEMS), optical circuitry, wireless circuitry, wireline circuitry, or a combination thereof.

The first device 102 can include a first storage unit 804. The first storage unit 804 can store the first software 812. The first storage unit 804 can also store the relevant information, such as images, video, maps, profiles, sensor data, navigation information, or any combination thereof.

The first storage unit 804 can be a volatile memory, a nonvolatile memory, an internal memory, an external memory, or a combination thereof. For example, the first storage unit 804 can be a nonvolatile storage such as non-volatile random access memory (NVRAM), Flash memory, disk storage, or a volatile storage such as static random access memory (SRAM).

The first storage unit 804 can include a first storage interface 818. The first storage interface 818 can be used for communication between the first storage unit 804 and other functional units in the first device 102. The first storage interface 818 can also be used for communication that is external to the first device 102.

The first storage interface 818 can receive information from the other functional units or from external sources, or can transmit information to the other functional units or to external destinations. The external sources and the external destinations refer to sources and destinations external to the first device 102.

The first storage interface 818 can include different implementations depending on which functional units or external units are being interfaced with the first storage unit 804. The first storage interface 818 can be implemented with technologies and techniques similar to the implementation of the first control interface 814.

The first device 102 can include a first communication unit 810. The first communication unit 810 can be for enabling external communication to and from the first device 102. For example, the first communication unit 810 can permit the first device 102 to communicate with the second device 104, an attachment, such as a peripheral device or a computer desktop, and the communication path 106.

The first communication unit 810 can also function as a communication hub allowing the first device 102 to function as part of the communication path 106 and not limited to be an end point or terminal unit to the communication path 106. The first communication unit 810 can include active and passive components, such as microelectronics or an antenna, for interaction with the communication path 106.

The first communication unit 810 can include a first communication interface 820. The first communication interface 820 can be used for communication between the first communication unit 810 and other functional units in the first device 102. The first communication interface 820 can receive information from the other functional units or can transmit information to the other functional units.

The first communication interface 820 can include different implementations depending on which functional units are being interfaced with the first communication unit 810. The first communication interface 820 can be implemented with technologies and techniques similar to the implementation of the first control interface 814.

The first device 102 can include a first user interface 802. The first user interface 802 allows a user (not shown) to interface and interact with the first device 102. The first user interface 802 can include a first user input (not shown). The first user input can include touch screen, gestures, motion detection, buttons, sliders, knobs, virtual buttons, voice recognition controls, or any combination thereof.

The first user interface 802 can include the first display interface 202. The first display interface 202 can allow the user to interact with the first user interface 802. The first display interface 202 can include a display, a video screen, a speaker, or any combination thereof.

The first control unit 808 can operate with the first user interface 802 to display information generated by the content delivery system 100 on the first display interface 202. The first control unit 808 can also execute the first software 812 for the other functions of the content delivery system 100, including receiving display information from the first storage unit 804 for display on the first display interface 202. The first control unit 808 can further execute the first software 812 for interaction with the communication path 106 via the first communication unit 810.

The first device 102 can include a first location unit 806. The first location unit 806 can provide the location of the first device 102. The first location unit 806 can access location information, current heading, and current speed of the first device 102, as examples.

The first location unit 806 can be implemented in many ways. For example, the first location unit 806 can function as at least a part of a global positioning system, an inertial content delivery system, a cellular-tower location system, a pressure location system, or any combination thereof.

The first location unit 806 can include a first location interface 816. The first location interface 816 can be used for communication between the first location unit 806 and other functional units in the first device 102. The first location interface 816 can also be used for communication that is external to the first device 102.

The first location interface 816 can receive information from the other functional units or from external sources, or can transmit information to the other functional units or to external destinations. The external sources and the external destinations refer to sources and destinations external to the first device 102.

The first location interface 816 can include different implementations depending on which functional units or external units are being interfaced with the first location unit 806. The first location interface 816 can be implemented with technologies and techniques similar to the implementation of the first control interface 814.

The first device 102 can include a first position unit 822. The first position unit 822 can provide the position, motion, and orientation of the first device 102. The first position unit 822 can access position information of the first device 102 including tilt, angle, direction, orientation, rotation, motion, acceleration, or a combination thereof.

The first position unit 822 can be implemented in many ways. For example, the first position unit 822 can be an accelerometer, a gyroscopic system, a MEMS system, an electrical contact system, an optical orientation system, or a combination thereof.

The first position unit 822 can include a first position interface 824. The first position interface 824 can be used for communication between the first position unit 822 and other functional units in the first device 102. The first position interface 824 can also be used for communication that is external to the first device 102.

The first position interface 824 can receive information from the other functional units or from external sources, or can transmit information to the other functional units or to external destinations. The external sources and the external destinations refer to sources and destinations external to the first device 102.

The first position interface 824 can include different implementations depending on which functional units or external units are being interfaced with the first position unit 822. The first position interface 824 can be implemented with technologies and techniques similar to the implementation of the first control interface 814.

For illustrative purposes, the first device 102 can be partitioned having the first user interface 802, the first storage unit 804, the first control unit 808, and the first communication unit 810, although it is understood that the first device 102 can have a different partition. For example, the first software 812 can be partitioned differently such that some or all of its function can be in the first control unit 808 and the first communication unit 810. Also, the first device 102 can include other functional units not shown in FIG. 8 for clarity.

The content delivery system 100 can include the second device 104. The second device 104 can be optimized for implementing the embodiment of the present invention in a multiple device embodiment with the first device 102. The second device 104 can provide the additional or higher performance processing power compared to the first device 102.

The second device 104 can include a second control unit 848. The second control unit 848 can include a second control interface 854. The second control unit 848 can execute a second software 852 to provide the intelligence of the content delivery system 100.

The second control unit 848 can be implemented in a number of different manners. For example, the second control unit 848 can be a processor, an embedded processor, a microprocessor, a hardware control logic, a hardware finite state machine (FSM), a digital signal processor (DSP), or a combination thereof.

The second control interface 854 can be used for communication between the second control unit 848 and other functional units in the second device 104. The second control interface 854 can also be used for communication that is external to the second device 104.

The second control interface 854 can receive information from the other functional units or from external sources, or can transmit information to the other functional units or to external destinations. The external sources and the external destinations refer to sources and destinations external to the second device 104.

The second control interface 854 can be implemented in different ways and can include different implementations depending on which functional units or external units are being interfaced with the second control interface 854. For example, the second control interface 854 can be implemented with electrical circuitry, microelectromechanical systems (MEMS), optical circuitry, wireless circuitry, wireline circuitry, or a combination thereof.

The second device 104 can include a second storage unit 844. The second storage unit 844 can store the second software 852. The second storage unit 844 can also store the relevant information, such as images, video, maps, profiles, sensor data, navigation information, or any combination thereof.

The second storage unit 844 can be a volatile memory, a nonvolatile memory, an internal memory, an external memory, or a combination thereof. For example, the second storage unit 844 can be a nonvolatile storage such as non-volatile random access memory (NVRAM), Flash memory, disk storage, or a volatile storage such as static random access memory (SRAM).

The second storage unit 844 can include a second storage interface 858. The second storage interface 858 can be used for communication between the second storage unit 844 and other functional units in the second device 104. The second storage interface 858 can also be used for communication that is external to the second device 104.

The second storage interface 858 can receive information from the other functional units or from external sources, or can transmit information to the other functional units or to external destinations. The external sources and the external destinations refer to sources and destinations external to the second device 104.

The second storage interface 858 can include different implementations depending on which functional units or external units are being interfaced with the second storage unit 844. The second storage interface 858 can be implemented with technologies and techniques similar to the implementation of the second control interface 854.

The second device 104 can include a second communication unit 850. The second communication unit 850 can enable external communication to and from the second device 104. For example, the second communication unit 850 can permit the second device 104 to communicate with the first device 102, an attachment, such as a peripheral device or a computer desktop, and the communication path 106.

The second communication unit 850 can also function as a communication hub allowing the second device 104 to function as part of the communication path 106 and not limited to be an end point or terminal unit to the communication path 106. The second communication unit 850 can include active and passive components, such as microelectronics or an antenna, for interaction with the communication path 106.

The second communication unit 850 can include a second communication interface 860. The second communication interface 860 can be used for communication between the second communication unit 850 and other functional units in the second device 104. The second communication interface 860 can receive information from the other functional units or can transmit information to the other functional units.

The second communication interface 860 can include different implementations depending on which functional units are being interfaced with the second communication unit 850. The second communication interface 860 can be implemented with technologies and techniques similar to the implementation of the second control interface 854.

The second device 104 can include a second user interface 842. The second user interface 842 allows a user (not shown) to interface and interact with the second device 104. The second user interface 842 can include a second user input (not shown). The second user input can include touch screen, gestures, motion detection, buttons, sliders, knobs, virtual buttons, voice recognition controls, or any combination thereof.

The second user interface 842 can include a second display interface 843. The second display interface 843 can allow the user to interact with the second user interface 842. The second display interface 843 can include a display, a video screen, a speaker, or any combination thereof.

The second control unit 848 can operate with the second user interface 842 to display information generated by the content delivery system 100 on the second display interface 843. The second control unit 848 can also execute the second software 852 for the other functions of the content delivery system 100, including receiving display information from the second storage unit 844 for display on the second display interface 843. The second control unit 848 can further execute the second software 852 for interaction with the communication path 106 via the second communication unit 850.

The second device 104 can include a second location unit 846. The second location unit 846 can provide the location of the second device 104. The second location unit 846 can access location information, current heading, and current speed of the second device 104, as examples.

The second location unit 846 can be implemented in many ways. For example, the second location unit 846 can function as at least a part of a global positioning system, an inertial content delivery system, a cellular-tower location system, a pressure location system, or any combination thereof.

The second location unit 846 can include a second location interface 856. The second location interface 856 can be used for communication between the second location unit 846 and other functional units in the second device 104. The second location interface 856 can also be used for communication that is external to the second device 104.

The second location interface 856 can receive information from the other functional units or from external sources, or can transmit information to the other functional units or to external destinations. The external sources and the external destinations refer to sources and destinations external to the second device 104.

The second location interface 856 can include different implementations depending on which functional units or external units are being interfaced with the second location unit 846. The second location interface 856 can be implemented with technologies and techniques similar to the implementation of the second control interface 854.

The second device 104 can include a second position unit 862. The second position unit 862 can provide the position, motion, and orientation of the second device 104. The second position unit 862 can access position information of the second device 104 including tilt, angle, direction, orientation, rotation, motion, acceleration, or a combination thereof.

The second position unit 862 can be implemented in many ways. For example, the second position unit 862 can be an accelerometer, a gyroscopic system, a MEMS system, an electrical contact system, an optical orientation system, or a combination thereof.

The second position unit 862 can include a second position interface 864. The second position interface 864 can be used for communication between the second position unit 862 and other functional units in the second device 104. The second position interface 864 can also be used for communication that is external to the second device 104.

The second position interface 864 can receive information from the other functional units or from external sources, or can transmit information to the other functional units or to external destinations. The external sources and the external destinations refer to sources and destinations external to the second device 104.

The second position interface 864 can include different implementations depending on which functional units or external units are being interfaced with the second position unit 862. The second position interface 864 can be implemented with technologies and techniques similar to the implementation of the second control interface 854.

For illustrative purposes, the second device 104 can be partitioned having the second user interface 842, the second storage unit 844, the second control unit 848, and the second communication unit 850, although it is understood that the second device 104 can have a different partition. For example, the second software 852 can be partitioned differently such that some or all of its function can be in the second control unit 848 and the second communication unit 850. Also, the second device 104 can include other functional units not shown in FIG. 8 for clarity.

The first communication unit 810 can couple with the communication path 106 to send information to the second device 104 in the first device transmission 832. The second device 104 can receive information in the second communication unit 850 from the first device transmission 832 of the communication path 106.

The second communication unit 850 can couple with the communication path 106 to send information to the first device 102 in the second device transmission 834. The first device 102 can receive information in the first communication unit 810 from the second device transmission 834 of the communication path 106. The content delivery system 100 can be executed by the first control unit 808, the second control unit 848, or a combination thereof.

The functional units in the first device 102 can work individually and independently of the other functional units. For illustrative purposes, the content delivery system 100 is described by operation of the first device 102. It is understood that the first device 102 can operate any of the modules and functions of the content delivery system 100. For example, the first device 102 can be described to operate the first control unit 808.

The functional units in the second device 104 can work individually and independently of the other functional units. For illustrative purposes, the content delivery system 100 can be described by operation of the second device 104. It is understood that the second device 104 can operate any of the modules and functions of the content delivery system 100. For example, the second device 104 is described to operate the second control unit 848.

For illustrative purposes, the content delivery system 100 is described by operation of the first device 102 and the second device 104. It is understood that the first device 102 and the second device 104 can operate any of the modules and functions of the content delivery system 100. For example, the first device 102 is described to operate the first control unit 808, although it is understood that the second device 104 can also operate the first control unit 808.

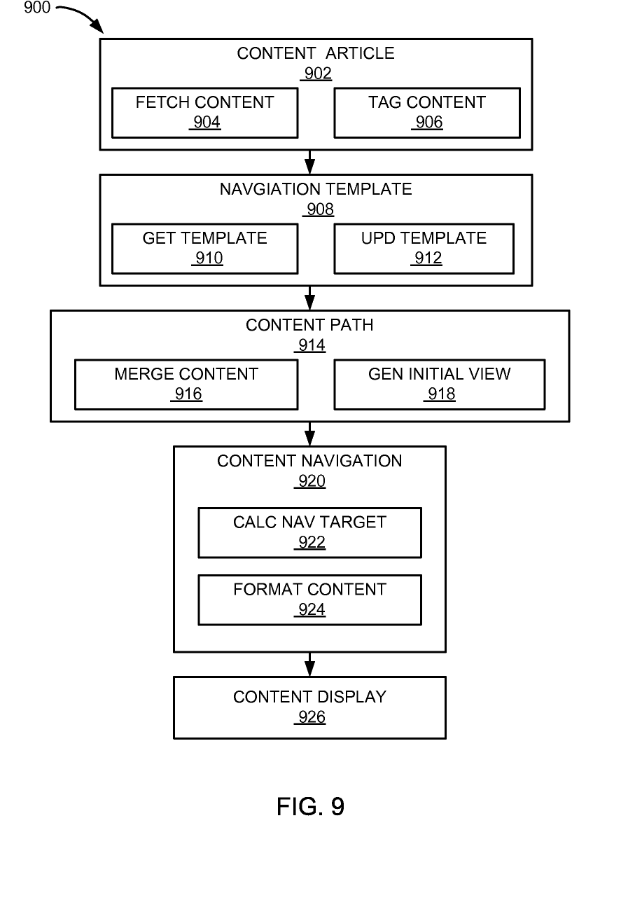

Referring now to FIG. 9, therein is shown a control flow 900 of the content delivery system 100 of FIG. 1. The control flow 900 describes the forming the content path 502 of FIG. 5 by combining the content article 204 of FIG. 2 and the navigation template 402 of FIG. 4.

The content delivery system 100 can include a content article module 902. The content article module 902 can provide and tag the content article 204. The content article module 902 can provide one or more instances of the content article 204.

The content article module 902 can provide the content article 204 in a variety of ways. For example, the content article module 902 can retrieve the content article 204 from a file stored in the first storage unit 804 of FIG. 8. In another example, the content article module 902 can retrieve content from a variety of the content sources 302 of FIG. 3 and aggregate the information to generate the content article 204.

The content article module 902 can include a fetch content module 904. The fetch content module 904 can locate and retrieve the content article 204. The fetch content module 904 can receive a user input (not shown) indicating a content choice and provide the content article 204 to satisfy the user's choice. The fetch content module 904 can retrieve the information and generate the content article 204 for viewing.

The fetch content module 904 can provide the content article 204 in a variety of ways. For example, the fetch content module 904 can retrieve the content article 204 from a file stored in the first storage unit 804. The content article 204 can be a single photo essay configured as a digital article from National Geographic™. The data file representing the content article 204 can be retrieved from the file storage memory and displayed on the screen of an Apple iPad™.

In another example, the fetch content module 904 can aggregate content from a variety of the content sources 302 and consolidate the information to generate the content article 204. The fetch content module 904 can retrieve Internet information customized for the user using the user's personal information and preferences. The fetch content module 904 can aggregate the content by retrieving information from the content sources 302 and selecting the content using a variety of filters.

In an illustrative example, the fetch content module 904 can retrieve content using the user's shopping history and profile that has been provided in a file. The content article module 902 can aggregate information from multiple shopping websites identified in the file where the user had already shopped and generate a customized multi-vendor catalog of items similar to items already purchased as indicated in the shopping history as the content article 204.

In another example, the fetch content module 904 can retrieve content using the user's reading and news preferences. The fetch content module 904 can aggregate information from a variety of news sources and blog to generate a customized news story as the content article 204.

For example, the fetch content module 904 can receive a file having a list of the user's preferred news websites and news topics, such as sports, top stories, or business. The fetch content module 904 can then retrieve news articles that match the preferred news topics and create a file containing the content article 204.

In yet another example, the fetch content module 904 can retrieve content using the user's music and video preferences and history. The fetch content module 904 can aggregate information from a variety of entertainment, music, and video websites to generate a multimedia presentation as the content article 204.

For example, the fetch content module 904 can receive an electronic message providing a recent playlist. The fetch content module 904 can retrieve songs on the playlist from an online music service to form a multimedia music presentation as the content article 204.

In still another example, the fetch content module 904 can retrieve content from the Internet using the user's friend's recommendations and favorite preferences. The fetch content module 904 can retrieve recommendation and favorite preference information by receiving the preference information electronically, such as in a data file. The preference information can be used to aggregate information retrieved with an internet search and generate a customized multimedia presentation file as the content article 204. The customized multimedia presentation can include favorite photos, news articles, rated music, notices, or a combination thereof.

In yet another example, the fetch content module 904 can retrieve content from the Internet using the user's current context including current location, destination, time, activity, requirements, preferences, or a combination thereof. For example, the fetch content module 904 can receive the current location information from a cell phone triangulation system and retrieve information about nearby restaurants from Yelp™. The fetch content module 904 can then generate a local entertainment profile document as the content article 204.

In still another example, the fetch content module 904 can retrieve content using the user's social graph, including social network, preferences, contacts, or a combination thereof. For example, the fetch content module 904 can retrieve information from a subject expert in the user's Linked In™ connections list and retrieve a scholarly report from the personal website of the subject expert to use as the content article 204.

The content article module 902 can include a tag content module 906. The tag content module 906 can identify the content elements 206 of FIG. 2 of the content article 204 by tagging the content elements 206 with the content tag 207 of FIG. 2.

Tagging the content elements 206 is assigning the content tag 207 to one of the content elements 206 in the content article 204. The content tag 207 can include a text label, a binary identifier, or a combination thereof.

In a further example, the content element type can include content types such as text block, image, subimage, graphic, audio element, video element, title, caption, or a combination thereof. Multiple instances of an individual content type can be enumerated, such as by annotating the content tag 207 with a content type and a number, such as “image 1”.

The content elements 206 of the content article 204 can be tagged in a variety of ways. For example, the content article 204 can be provided as a file with the content elements 206 already identified and each of the content elements 206 having the content tag 207 assigned.

In another example, the tag content module 906 can apply content recognition techniques to identify the content elements 206 and assign the content tag 207 to the content elements 206. A Joint Photographic Experts Group (JPEG) image file embedded in the content article 204 could be detected using pre-defined identifiers in the JPEG file format and tagged as a “subimage”. In yet another example, the content elements 206 can be assigned the content tag 207 in a manual process.

For example, the content article 204 can be a digital magazine story having text, headings, images, graphics, audio clips, video clips, or a combination thereof. The tag content module 906 can identify the various types of the content elements 206 in the magazine article using the data characteristics of the file type of the content and assign the content tag 207 to each identifiable instance of the content elements 206. In another example, the title 210 of FIG. 2 of the content article 204 can be identified using the font size, capitalization, and position of the text and assigned the content tag 207 indicating “title”.

The content delivery system 100 can include a navigation template module 908, which can be coupled to the content article module 902. The navigation template module 908 can generate the navigation template 402 of FIG. 4 for the content article 204.

The navigation template module 908 can generate the navigation template 402 in a variety of ways. For example, the navigation template 402 can be a pre-defined template provided with the file of the content article 204, created using the content elements 206 of the content article 204, formed manually, or a combination thereof.

The navigation template module 908 can include a get template module 910. The get template module 910 can provide the navigation template 402 for navigating the content article 204. The get template module 910 can provide the navigation template 402 from a pre-defined file, create the navigation template 402 using the content article 204, formed manually, or a combination thereof.

The get template module 910 can provide the navigation template 402 by retrieving a pre-defined template, such as by fetching from a file system, receiving over the communication path 106 of FIG. 1, or a combination thereof. The navigation template 402 can be a template manually or automatically customized for the content article 204, a template for general navigation of different instances of the content article 204, a pre-defined template for a category of the content article 204, or a combination thereof.

In an illustrative example, the get template module 910 can create the navigation template 402 using the content elements 206 of the content article 204. The get template module 910 can create one of the template regions 404 of FIG. 4 for each of the content elements 206 in the content article 204.

Each of the template regions 404 can be created by detecting the content tag 207 associated with each of the content elements 206 and creating an instance of the template regions 404. For example, the size and location of the template regions 404 can be calculated using the size and location of the content elements 206 as indicated by the content tag 207.

The get template module 910 can create one of the template regions 404 for each one of the content elements 206. Each of the template regions 404 can be linked to one of the content elements 206 by having an information value pointing to the associated instance of the content elements.

The get template module 910 can determine the navigation destination 406 of FIG. 4 for each of the template regions 404. The template regions 404 can be linked to a single instance of the navigation destination 406 or a plurality of instances of the navigation destination 406.

The navigation destination 406 can be determined in a number of ways. For example, the navigation destination 406 of the template regions 404 can be determined using the same order the content elements 206 are presented in the content article 204. The first instance of the template regions 404 associated with the first instance of the content elements 206 can have the navigation destination 406 set to the second instances of the template regions 404 associated with the second instance of the content elements 206. The navigation destination 406 can include an information link associated with the next one of the content elements 206.

In another example, the navigation destination 406 can be determined using a rule-based system using the relative size and importance of the content elements 206 as listed in a table. The rule-based system can create one of the template regions 404 to be associated with one of the content elements 206 having the largest pixel size and assign one of the template regions 404 associated with one of the content elements 206 having the next largest pixel size as the navigation destination 406.

In yet another example, the navigation destination 406 of the template regions 404 can be determined using an interactive process where the user can manually identify the navigation destination 406 of each of the template regions 404, such as by entering the identification of the desired instance of the template regions 404. The template regions 404 can be presented using a user interface and the navigation destination 406 from each of the template regions 404 can be associated to another of the template regions 404. The navigation destination 406 can be associated to one or more of the template regions 404.

The navigation template module 908 can include an update template module 912. The update template module 912 can update the template regions 404 of the navigation template 402 including modifying the navigation destination 406, the formatting command 408 of FIG. 4, the focus cue 410 of FIG. 4, other properties of the template regions 404, or a combination thereof.

The update template module 912 can update the navigation template 402 in a variety of ways. For example, the update template module 912 can update the navigation destination 406 of one of the template regions, such as the source template region 424 of FIG. 4, including adding, removing, or changing the navigation destination 406 of the source template region 424, such as the target template region 426 of FIG. 4.

The navigation destination 406 can be updated manually by editing the text of an existing instance of the navigation destination 406. In another example, the navigation destination 406 can be updated by adding an additional entry also linking to the title 210 of the content article 204 to the navigation destination 406.

The target template region 426 identifies the location to go to when navigating away from the source template region 424. The source template region 424 can include one or more instances of the navigation destination 406 for navigating to different instances of the target template region 426 depending on the navigation command 702 of FIG. 7 received during navigation.

The update template module 912 can update the formatting command 408 of one of the template regions 404, such as the target template region 426, including adding, removing, or changing the formatting command 408. For example, the update template module 912 can change the formatting command 408 by manually changing the zoom factor for the target template region 426. In another example, the update template module 912 can automatically change the font size for the target template region 426 to accommodate the display size 203 of FIG. 2.

The update template module 912 can update the focus cue 410 of one of the template regions 404, such as the target template region 426, including adding, removing, or changing the focus cue 410. For example, the update template module 912 can change the focus cue 410 by changing the color palette of the source template region 424 to black and white only. In another example, the update template module 912 can remove the focus cue 410 for the target template region 426.

The update template module 912 can update the navigation template 402 provided as a pre-defined template to add further customization to the template. The update template module 912 can update the navigation template 402 created from the content article 204 to add additional destination for navigation.

The content delivery system 100 can include a content path module 914, which can be coupled to the navigation template module 908. The content path module 914 can generate the content path 502 of FIG. 5 by combining the content article 204 with the navigation template 402.

The content path 502 identifies the navigational route of the display content 205 of FIG. 2 for the content article 204. For example, the content path 502 can include the content nodes 504 of FIG. 5. The set of the content nodes 504 in the content path 502 is determined by the navigation destination 406 of the template regions 404. Each of the content nodes 504 can be displayed as the display content 205 by applying the formatting command 408 and the focus cue 410 to the content elements 206.

The content path module 914 can include a merge content module 916. The merge content module 916 can form the content nodes 504 of the content path 502 by combining the content elements 206 with the template regions 404.

The content elements 206 can be combined with the template regions 404 by applying the formatting command 408 of one of the template regions 404 to the associated instance of the content elements 206. For example, one of the content nodes 504 can be formed by combining one of the content elements 206, such as the subimage 216 of FIG. 2, with the formatting command 408 of one of the template regions 404, such as formatting information to zoom the subimage 216 by 200% and convert the color palette to black and white.

The merge content module 916 can form the source content node 530 of FIG. 5 by combining the source template region 424 with the source content element 506 of FIG. 5. The merge content module 916 can form the target content node 532 of FIG. 5 by combining the target template region 426 with the target content element 508 of FIG. 5.

The content nodes 504 represent entries along the content path 502 of the content article 204 that can be reached by navigating from one of the template regions 404 to another of the template regions 404 linked by the navigation destination 406 of the template regions 404. For example, if the source template region 424 includes the navigation destination 406 having two target destinations, then each instance of the target template region 426 can form one of the content nodes 504.

Each of the content nodes 504 represents one of the content elements 206 that can be linked to the formatting command 408 of the target template region 426. The total number of the content nodes 504 can be determined by calculating the number of path permutations of the navigation destination 406 of the template regions 404 of the navigation template 402. For example, if the navigation destination 406 of the source template region 424 has two instances of the target template region 426, then each destination will form a separate instance of the content nodes 504.

The merge content module 916 can form the content nodes 504 in a variety of ways. For example, the content nodes 504 can be formed by calculating all of the routes connecting each of the template regions 404 to one another using the navigation destination 406 and applying the formatting command 408 to each associated instance of the content elements 206. In another example, the merge content module 916 can form the content nodes 504 incrementally by calculating the instances of the target content node 532 directly navigable from the source content node 530.

The content path module 914 can include a generate initial view module 918. The generate initial view module 918 can generate the display content 205 as the initial view 304 of FIG. 3 of the content article 204.

The initial view 304 of the content article 204 is the first of the content nodes 504 of the content path 502. The initial view 304 can represent the starting point of the content path 502. The initial view 304 can be displayed as the display content 205 for the navigation template 402 and a plurality of the content elements 206.

The initial view 304 can act as an overview or introduction for the content article 204 and can have different viewing characteristics than other instances of the display content 205. For example, the initial view 304 can include a zoom factor calculated to display all of the content elements 206 on the display interface 202 of FIG. 2.

The content delivery system 100 can include a content navigation module 920, which can be coupled to the content path module 914. The content navigation module 920 can allow navigation along the content path 502 from the source content node 530 of FIG. 5 to the target content node 532 of FIG. 5 by receiving the navigation command 702 and displaying the display content 205 of the target content node 532 identified by the navigation command 702.

The content navigation module 920 can receive the navigation command 702 for the content article 204 and navigate to the instance of the content nodes 504 indicated by the navigation destination 406. The content navigation module 920 can display the target content node 532 as the display content 205 on the display interface 202.

The content navigation module 920 can include a calculate navigation target module 922. The calculate navigation target module 922 can receive the navigation command 702 for the current instance of the source content node 530 and determine the target content node 532 for the navigation command 702 received.

The calculate navigation target module 922 can receive the navigation command 702 from the content delivery system, such as an input from the first user interface 802 of FIG. 8. The navigation command 702 can include a touchscreen gesture, a three-dimensional gesture, a keyboard command, a button click, or a combination thereof.

For example, the navigation command 702 can be a touchscreen gesture moving from the center of the display interface 202 toward the target template region 426. In another example, the navigation command 702 can be a “next” gesture indicating that navigation should be to the target content node 532 indicated as the default target for the source content node 530.

The calculate navigation target module 922 can compare the navigation command 702 with the navigation destination 406 of the source template region 424 of the source content node 530 to determine the target content node 532. The navigation destination 406 can include a list of valid instances of the navigation command 702 coupled with a list of instances of the target content node 532. By matching the navigation command 702 to the target content node 532 indicated in the navigation destination 406 of the source content node 530, the calculate navigation target module 922 can identify the target content node 532 for the navigation command 702 that was received.

For example, the navigation destination 406 for the source content node 530, such as one of the content nodes 504 representing the initial view 304, can include a list of two instances of the navigation command 702, such as a “left gesture” and a “right gesture”. The navigation destination 406 can also include two associated instances of the target content node 532, such as the content nodes 504 representing the “handle caption” and the “head text block”.

The content delivery system 100 can navigate to the target content node 532 representing the “handle caption” if the navigation command 702 is the “left gesture” or to the “head text block” if the navigation command 702 is the “right gesture”. If the navigation command 702 is not identified in the source content node 530 of FIG. 5, then the target content node 532 can be assigned to the default instance of the target content node 532 of FIG. 5.

It has been discovered that an embodiment of the present invention provides increased functionality and improved navigation by processing multiple instances of the navigation command 702 to determine multiple instances of the target content node 532. By providing content-sensitive processing of the navigation command 702, the content delivery system 100 can improve the magazine reading experience.

The content navigation module 920 can include a format content module 924. The format content module 924 can format the display content 205 of the target content node 532 using the formatting command 408 and the focus cue 410 after the target content node 532 has been determined by the calculate navigation target module 922.

The format content module 924 can format the display content 205 of the target content node 532 by applying the formatting command 408 of the target content node 532 to the target content element 508. For example, the format content module 924 can format the subimage 216 using the focus cue 410 by adding a dashed-line frame around the subimage 216 to draw attention to the subimage 216.

After the target content node 532 has been formatted, the format content module 924 can calculate the quality factor 534 of FIG. 5 for the display content 205 of the target content node 532 and compare the quality factor 534 for the display content 205 to the quality threshold 536 of FIG. 5. If the quality factor 534 is below the quality threshold 536, then the format content module 924 can reformat the target content node 532 to increase the quality factor 534. For example, the format content module 924 can calculate the quality factor 534 of the target content node 532 by determining the dimensions of the graphic 214 of FIG. 2 and comparing to the display size 203. If the dimensions of the graphic 214 are half those of the display size 203, then the quality factor 534 can be set to a value of 50%. The quality threshold 536 can be set to 80% indicating that the display of the graphic 214 must be at least 80% of the display size 203. Because the quality factor 534 is less than the quality threshold 536, the format content module 924 can reformat the target content node 532 by zooming the graphic 214 by a factor of 1.6 and the updated instance of the quality factor 534 can be increased to 80%.

The content delivery system 100 can include a content display module 926, which can be coupled to the content navigation module 920. The content display module 926 can display the display content 205 of the content article 204 on the display interface 202.

The content display module 926 can display the source content element 506 of the content article 204 by displaying the source content node 530 on the display interface 202. The content display module 926 can display the target content element 508 of the content article 204 by displaying the target content node 532 on the display interface 202.

The content display module 926 can display the display content 205 on the display interface 202 when traversing from the source content node 530 to the target content node 532. For example, the content display module 926 can display the display content 205 as a smooth transition along a curved path from the title 210 to the text block 218 of FIG. 2, when traversing along the panning path 542 of FIG. 5 from the source content node 530 to the target content node 532. After the content display module 926 has completed, control flow can pass back to the content navigation module 920 to allow continued navigation of the content article 204 along the content path 502.

The physical transformation from navigating the content path 502 with the navigation command 702 through the content article 204 results in movement in the physical world, such as people using the first device 102 of FIG. 1, based on the operation of the content delivery system 100. As the movement in the physical world occurs, the movement itself creates additional information, such as the gestures of the navigation command 702 that are converted back into navigating along the content path 502 of the content article 204 for continued operation of the content delivery system 100 and to continue movement in the physical world.

The first software 812 of FIG. 8 of the first device 102 can include the content delivery system 100. For example, the first software 812 can include the content article module 902, the navigation template module 908, the content path module 914, the content navigation module 920, and the content display module 926.

The first control unit 808 of FIG. 8 can execute the first software 812 for the content article module 902 to generate the content article 204. The first control unit 808 can execute the first software 812 for the navigation template module 908 to generate the navigation template 402. The first control unit 808 can execute the first software 812 for the content path module 914 to generate the content path 502. The first control unit 808 can execute the first software 812 for the content navigation module 920 to generate the content article 204 of FIG. 2. The first control unit 808 can execute the first software 812 for the content display module 926 to display the display content 205.

The second software 852 of FIG. 8 of the second device 104 of FIG. 8 can include the content delivery system 100. For example, the second software 852 can include the content article module 902, the navigation template module 908, the content path module 914, the content navigation module 920, and the content display module 926.

The second control unit 848 of FIG. 8 can execute the second software 852 for the content article module 902 to generate the content article 204. The second control unit 848 can execute the second software 852 for the navigation template module 908 to generate the navigation template 402. The second control unit 848 can execute the second software 852 for the content path module 914 to generate the content path 502. The second control unit 848 can execute the second software 852 for the content navigation module 920 to generate the content article 204. The second control unit 848 can execute the second software 852 for the content display module 926 to display the display content 205.

The content delivery system 100 can be partitioned between the first software 812 and the second software 852. For example, the second software 852 can include the content article module 902, the navigation template module 908, and the content path module 914. The second control unit 848 can execute modules partitioned on the second software 852 as previously described.

The first software 812 can include the content navigation module 920, and the content display module 926. Depending on the size of the first storage unit 804 of FIG. 8, the first software 812 can include additional modules of the content delivery system 100. The first control unit 808 can execute the modules partitioned on the first software 812 as previously described.

The first control unit 808 can operate the first communication unit 810 of FIG. 8 to send the content article 204 to the second device 104. The first control unit 808 can operate the first software 812 to operate the first location unit 806 of FIG. 8 and the first position unit 822 of FIG. 8. The second communication unit 850 of FIG. 8 can send the display content 205 to the first device 102 through the communication path 106.

The content delivery system 100 describes the module functions or order as an example. The modules can be partitioned differently. For example, the content article module 902 and the navigation template module 908 can be combined. Each of the modules can operate individually and independently of the other modules.

Furthermore, data generated in one module can be used by another module without being directly coupled to each other. For example, the content path module 914 can receive the content article 204 from the content article module 902. The content article module 902, the navigation template module 908, the content path module 914, the content navigation module 920, and the content display module 926 can be implemented in as hardware accelerators (not shown) within the first control unit 808 or the second control unit 848, or can be implemented in as hardware accelerators (not shown) in the first device 102 or the second device 104 outside of the first control unit 808 or the second control unit 848.

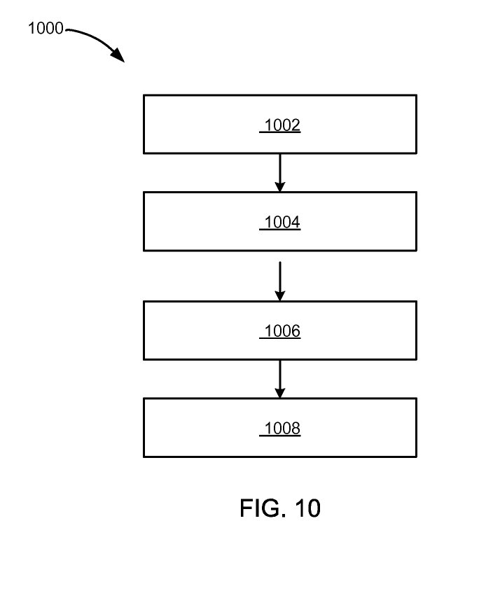

Referring now to FIG. 10, therein is shown a flow chart of a method 1000 of operation of the content delivery system 100 of FIG. 1 in a further embodiment of the present invention. The method 1000 includes: providing a content article having content elements in a block 1002; generating a navigation template with a source template region and a target template region, the source template region having a navigation destination linking to the target template region and the target template region having a formatting command in a block 1004; generating a content path having content nodes by combining the target template region of the navigation template with one of the content elements and formatting one of the content elements with the formatting command in a block 1006; and receiving a navigation command for navigating to the navigation destination of the target template region of one of the content nodes for displaying the content article on a device in a block 1008.

An embodiment of the present invention provides that forming the content nodes 504 of FIG. 5 using one of the template regions 404 of FIG. 4 having the navigation destination 406 of FIG. 4 and the formatting command 408 of FIG. 4 improves the readability of the content article 204 of FIG. 2. By navigating along the content path 502 of FIG. 5 in a particular order, the effectiveness of presentation of the content article 204 is enhanced over a random or non-specific order by allowing a pre-defined route that presents the content elements 206 of FIG. 2 in a pre-defined and content-based order.

An embodiment of the present invention provides that formatting one of the content elements 206 by applying the formatting command 408 to one of the content elements 206 increases the readability of the content article 204 by increasing the quality factor 534 of FIG. 5 of the display content 205 of FIG. 2. Applying the formatting command 408, including the zoom factor 540 of FIG. 5, to one of the content elements 206 having the text block 218 of FIG. 2 increases the size of the text and increases readability.

An embodiment of the present invention provides that configuring the source template region 424 of FIG. 4 to have multiple instances of the target template region 426 of FIG. 4 and navigating to different instances of the target template region 426 increases reading performance and flexibility. Multiple destination instances of the target template region 426 for the source template region 424 allows for multiple reading scenarios and providing an improved user experience and enhanced readability.

An embodiment of the present invention provides increased functionality and improved navigation by processing multiple instances of the navigation command 702 to determine multiple instances of the target content node 532 of FIG. 5. By providing content-sensitive processing of the navigation command 702 of FIG. 7, the content delivery system 100 can improve the magazine reading experience.

The resulting method, process, apparatus, device, product, and/or system is straightforward, cost-effective, uncomplicated, highly versatile, accurate, sensitive, and effective, and can be implemented by adapting known components for ready, efficient, and economical manufacturing, application, and utilization. Another important aspect of an embodiment of the present invention is that it valuably supports and services the historical trend of reducing costs, simplifying systems, and increasing performance. These and other valuable aspects of an embodiment of the present invention consequently further the state of the technology to at least the next level.

While the invention has been described in conjunction with a specific best mode, it is to be understood that many alternatives, modifications, and variations will be apparent to those skilled in the art in light of the aforegoing description. Accordingly, it is intended to embrace all such alternatives, modifications, and variations that fall within the scope of the included claims. All matters set forth herein or shown in the accompanying drawings are to be interpreted in an illustrative and non-limiting sense.

What is claimed is:

1. A content delivery system comprising:
a content article module for providing a content article having content elements;
a navigation template module, coupled to the content article module, for generating a navigation template with a source template region and a target template region, the source template region having a navigation destination linking to the target template region and the target template region having a formatting command;
a content path module, coupled to the navigation template module, for generating a content path having content nodes by combining the target template region of the navigation template with one of the content elements and formatting one of the content elements with the formatting command; and
a content navigation module, coupled to the content path module, for receiving a navigation command for navigating to the navigation destination of the target template region of one of the content nodes for displaying the content article on a device.

2. The system as claimed in claim 1 wherein the navigation template module is for linking the navigation destination to a plurality of the target template region.

3. The system as claimed in claim 1 wherein the navigation template module is for formatting one of the content elements using the formatting command having a zoom factor for increasing the size of one of the content elements.

4. The system as claimed in claim 1 wherein the content navigation module includes a format content module for calculating a quality factor for one of the content nodes and for comparing a quality threshold to the quality factor for reformatting one of the content elements when the quality factor is below the quality threshold.

5. The system as claimed in claim 1 wherein the content navigation module is for formatting one of the content elements for displaying a focus cue.

6. The system as claimed in claim 1 further comprising a content display module, coupled to the content navigation module, for displaying the source content element and the target content element when navigating from a source content node to a target content node.

7. The system as claimed in claim 1 further comprising a content display module, coupled to the content navigation module, for traversing along a panning path from one of the template regions to another of the template regions.

8. The system as claimed in claim 1 wherein the content path module is for navigating from a source content node to a target content node along the content path.

9. The system as claimed in claim 1 wherein:
the content path module is for generating an initial view for the content article; and further comprising:
a content display module, coupled to the content navigation module, for displaying the initial view.

10. The system as claimed in claim 1 wherein:
the content article module is for assigning a content tag to the source content element; and
the navigation template module is for creating the source template region from the content tag of the source content element.

11. A method of operation of a content delivery system comprising:
providing a content article having content elements;
generating a navigation template with a source template region and a target template region, the source template region having a navigation destination linking to the target template region and the target template region having a formatting command;
generating a content path having content nodes by combining the target template region of the navigation template with one of the content elements and formatting one of the content elements with the formatting command; and
receiving a navigation command for navigating to the navigation destination of the target template region of one of the content nodes for displaying the content article on a device.

12. The method as claimed in claim 11 wherein generating the navigation template includes linking the navigation destination to a plurality of the target template region.

13. The method as claimed in claim 11 where generating the navigation template includes formatting one of the content elements using the formatting command having a zoom factor for increasing the size of one of the content elements.

14. The method as claimed in claim 11 further comprising:
calculating a quality factor for one of the content nodes; and
comparing a quality threshold to the quality factor for reformatting one of the content elements when the quality factor is below the quality threshold.

15. The method as claimed in claim 11 wherein displaying the content article includes formatting one of the content elements for displaying a focus cue.

16. The method as claimed in claim 11 wherein providing the content article having the content elements includes providing the content elements with a source element and a target content element.

17. The method as claimed in claim 11 further comprising traversing a panning path from one of the template regions to another of the template regions.

18. The method as claimed in claim 11 wherein generating the content path includes navigating from a source content node to a target content node along the content path.

19. The method as claimed in claim 11 wherein:
generating the content path includes generating an initial view for the content article; and
displaying the content article includes displaying the initial view.

20. The method as claimed in claim 11 wherein:
providing the content article includes assigning a content tag to the source content element; and
generating the navigation template includes creating the source template region from the content tag of the source content element.
